(19) United States
(12) Patent Application Publication
(10) Pub. No.: US 2019/0216115 A1
(43) Pub. Date: Jul. 18, 2019

(54) STABLE FLAVOR COMPOSITIONS CONTAINING MINT LEAVES

(71) Applicant: WM. WRIGLEY JR. COMPANY, Chicago, IL (US)

(72) Inventors: Sonya JOHNSON, Chicago, IL (US); Shanna DABSON, Chicago, IL (US); Lisa TRAN, Chicago, IL (US); Minmin TIAN, Chicago, IL (US)

(21) Appl. No.: 16/334,436

(22) PCT Filed: Sep. 22, 2017
(86) PCT No.: PCT/US17/52866

§ 371 Date: Mar. 19, 2019

Related U.S. Application Data
(60) Provisional application No. 62/398,886, filed on Sep. 23, 2016.

(51) Int. Cl. A23L 27/10; A23G 4/06

(52) U.S. Cl. CPC A23L 27/10; A23V 2002/00; A23G 4/068

(57) ABSTRACT

Flavor compositions containing mint leaves are provided. The flavor compositions further include a mint flavor, such as oils and extracts containing menthol. The flavor compositions can be used in confectionery products, such as chewing gums. Specifically, flavor compositions are provided that include mint flavor and mint leaves, and which can be stable against microbial growth and have enhanced color and flavor.

### FIELD

The presently disclosed subject matter relates to stable flavor compositions including mint leaves, particularly for use in confectionery products such as chewing gums. Specifically, the present disclosure is directed to flavor compositions that include mint leaves in addition to a mint flavor. The flavor compositions can be stable against microbial growth, and have enhanced and stable color and flavor.

### BACKGROUND

There is interest in incorporating natural products into confectionery products, such as chewing gums. For example, the use of mint leaves (i.e., plant material from the above-ground parts of plants in the genus Mentha) in a confectionery product can provide an enhanced sensory experience to the consumer. However, it is known that incorporation of plant material, such as mint leaves, can increase the amount of microbial growth within a confectionery product. Moreover, the odor and taste of confectionery products including mint leaves can degrade over time, resulting in off-notes or flavors. The color of the mint leaves can also degrade from a green color to a gray color over time, resulting in a less visually appealing product.

To address these concerns, it is known to incorporate artificial chemical additives, such as triacetin (i.e., the triacetic ester of 1,2,3-trihydroxypropane) into confectionery products, which can act as a diluent and have a preservative effect on the mint leaves. However, artificial chemical additives can impact the sensory experience of the confectionery product, and make it less desirable to consumers.

As such, there is a need for improved flavor compositions that can be incorporated into a confectionery product that include mint leaves and that have improved taste, odor, and color stability, and which can remain stable over time with reduced levels of microbial growth. The presently disclosed subject matter addresses these and other needs as discussed in detail below.

### SUMMARY OF THE INVENTION

The present disclosure provides flavor compositions including mint leaves and a mint flavor. Although mint leaves alone can have high levels of microbes, it was found that the addition of mint flavor to a flavor composition that includes mint leaves can provide sufficient micro kill to permit the safe use of mint leaves in confectionery products. Additionally, the combination of mint leaves and mint flavor can provide an enhanced sensory experience as compared to mint leaves mixed with a diluent, such as triacetin, particularly when the confectionery products are protected from light and moisture.

In certain aspects, the present disclosure provides a flavor composition. As embodied herein, the flavor composition can comprise mint leaves and at least one mint flavor, and the flavor composition can have improved micro kill as compared to a composition containing the mint leaves and no mint flavor. In certain embodiments, the flavor composition containing mint flavor and mint leaves can have a microbe level reduction of at least 1 log as compared to the composition containing the mint leaves and no mint flavor.

In certain embodiments, the flavor composition can include mint leaves in an amount of from about 1 wt-% to about 90 wt-%. For example, and not limitation, the flavor composition can include mint leaves in an amount of from about 25 wt-% to about 60 wt-%. In certain embodiments, the mint leaves can be ground mint leaves. In certain embodiments, the flavor composition can include mint flavor in an amount of from about 10 wt-% to about 99 wt-%. For example, and not limitation, the mint flavor is present in an amount of from about 35 wt-% to about 75 wt-%.

In certain embodiments, the mint flavor comprises at least one natural mint oil and/or another plant extract. For example, and not limitation, the mint flavor can include menthol. In certain embodiments, the flavor composition further includes magnolia bark extract.

The present disclosure further provides confectionery products including flavor compositions comprising mint leaves and at least one mint flavor. In certain embodiments, the confectionery product is a chewing gum. In certain embodiments, the flavor composition is present in the chewing gum in an amount of from about 0.01 wt-% to about 20 wt-%. As embodied herein, the chewing gum can have improved micro kill, for example, less than about 250 cfu/g of mold and/or less than about 250 cfu/g of yeast and/or less than about 25,000 cfu/g of aerobic plate count (APC) and/or less than about 50 MPN/g total coliforms and/or less than about <3 MPN/g of E. coli and/or a 375 g sample of the chewing gum can have no detectable amount of salmonella.

The present disclosure also provides methods of making chewing gums. For example, a method of making a chewing gum can include blending mint leaves and a mint flavor to form a flavor composition and, thereafter, incorporating the flavor composition with a gum base and bulking agent to form the chewing gum. In certain embodiments, the method can further include grinding the mint leaves prior to the blending. In certain embodiments, the flavor composition can be aged for at least about 7 days. Additionally or alternatively, the flavor composition can be maintained at a temperature of from about 40° C. to about 60° C. for from about 15 minutes to 1 hour.

The foregoing has outlined broadly the features and technical advantages of the present application in order that the detailed description that follows may be better understood. Additional features and advantages of the application will be described hereinafter which form the subject of the claims of the application. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### BRIEF DESCRIPTION OF THE DRAWINGS

FIGS. 1A-1B provide microscopic images of coarse mint leaves, as described in Example 6, along with measurements of particle length from each image. FIG. 1A is an image at 5× magnification and FIG. 1B is an image at 20× magnification.

FIGS. 2A-2B provide microscopic images of ground mint leaves that were ground from coarse mint leaves, as described in Example 6, along with measurements of particle length from each image. FIG. 2A is an image at 5× magnification and FIG. 2B is an image at 20× magnification.

FIGS. 3A-3B provide microscopic images of large leaf mint leaves, as described in Example 6. FIG. 4A is an image at 5× magnification and further includes measurements of particle length. FIG. 3B is an image at 20× magnification.

FIGS. 4A-4B provide microscopic images of ground mint leaves that were ground from large leaf mint leaves, as described in Example 6, along with measurements of particle length from each image. FIG. 4A is an image at 5× magnification and FIG. 4B is an image at 20× magnification.

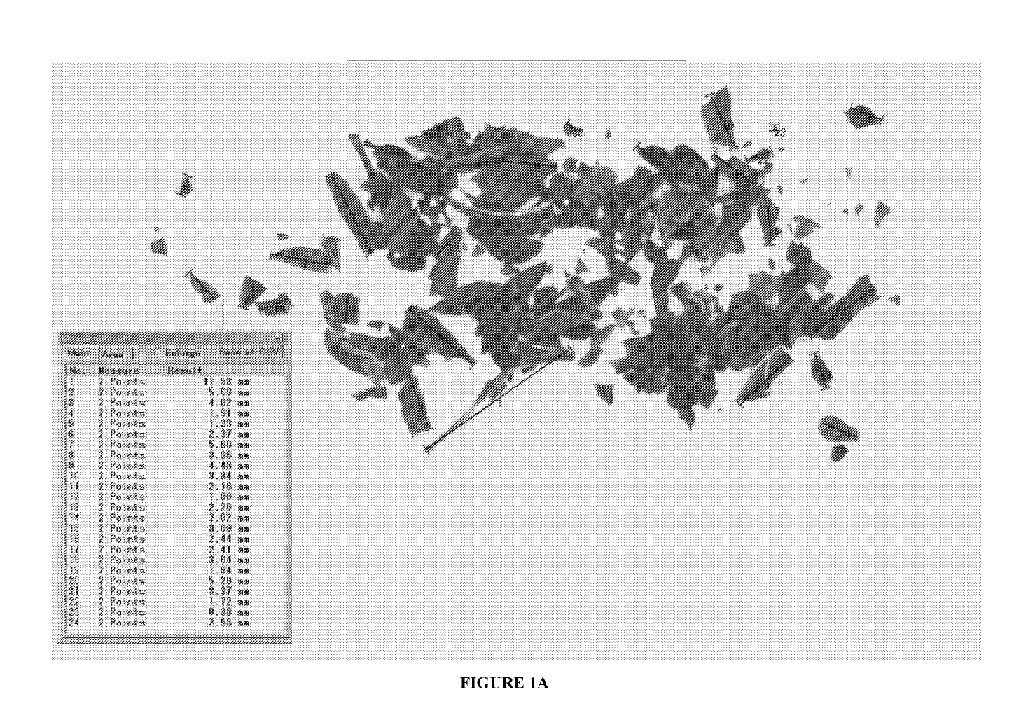

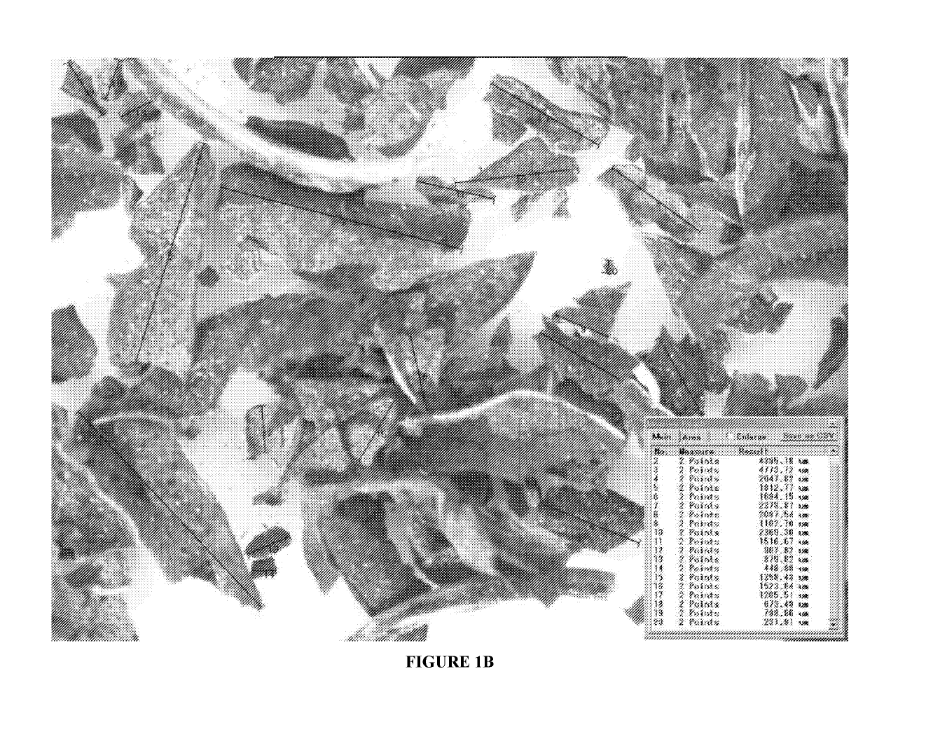

### DETAILED DESCRIPTION

As noted above, to date, there remains a need in the art for flavor compositions that include mint leaves, but that also have improved taste, odor, and color stability, and which can remain stable over time with reduced levels of microbial growth. The present disclosure provides such flavor compositions that combine mint leaves and mint flavor. Moreover, these flavor compositions can be incorporated into a confectionery product, such as a chewing gum.

### 1. Definitions

The terms used in this specification generally have their ordinary meanings in the art, within the context of this disclosed subject matter and in the specific context where each term is used. Certain terms are discussed below, or elsewhere in the specification, to provide additional guidance to the practitioner in describing the compositions and methods of the disclosed subject matter and how to make and use them.

As used herein, the use of the word “a” or “an” when used in conjunction with the term “comprising” in the claims and/or the specification may mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value.

As used herein, “food product” or “food product composition” includes ingestible products including but not limited to human foods, animal or pet foods, pharmaceutical products, and consumer products.

As used herein, the term “confectionery product” refers to a sweet or dessert edible composition. Confectionery products can include, but are not limited to, cakes, cookies, pies, candies (hard and soft), compressed mints, chewing gums, gelatins, ice creams, sorbets, jams, jellies, chocolates, fudge, fondant, liquorice, taffy, and combinations thereof.

As used herein, the term “chewing gum” refers to a flavored substance intended for chewing. The term as used herein also includes bubble gum and confectionery products containing chewing gum. In certain embodiments, chewing gum forms include, but are not limited to, tablets, sticks, solid balls, hollow balls, cut and wrap, and pellets or pillows. Unless otherwise specified, all percentages used herein are weight percents. As used herein, chewing gum base contains a gum non-filler base portion and a gum base filler portion.

As used herein, “flavor” shall include aroma, odor and/or taste. The flavor composition can be in a variety of forms including but not limited to a liquid, dry powder, spray, paste, suspension, other solid form, and any combination thereof. The flavor can be a natural composition, an artificial composition or any combination thereof.

As used herein, the term “micro kill” refers to the effect a composition has on reducing or eliminating the levels of microbes, including, for example and not limitation, molds, yeasts, and bacteria. Levels of microbes can be directly assessed, or estimated according to various methods as known in the art, including mold plate count and aerobic plate count (APC). Moreover, levels of microbes can refer to an amount or estimated amount of a particular organism, or can refer to the presence or absence of the organism in absolute terms (i.e., as a positive or negative result).

As used herein, the term “mint leaves” refers to leaf, stem, and other plant material from the above-ground parts of plants in the genus Mentha.

As used herein, “ground mint leaves” refers to mint leaves that have been dried and processed into fine particles. The ground mint leaves may resemble a powder, or can be composed of larger, generally homogenous particles. For example, the mint leaves can be ground using a Turkish Grind for one or more repetitions. In certain embodiments, the ground mint leaves can be ground to an average particle size of from about 1 mm to about 2 mm.

As used herein, “coarse mint leaves” refers to mint leaves that have not been processed to reduce size, or which have been processed into larger flakes. For example, the coarse mint leaves can be prepared by chopping, dicing, hashing, breaking, or otherwise fracturing mint leaves into smaller fragments. The coarse mint leaves can have generally homogenous particle sizes, or can have varied particle sizes. The particle sizes of coarse mint leaves will generally be larger than those of ground mint leaves. In certain embodiments, the coarse mint leaves can have an average particle size of from about 3 mm to about 30 mm. As used herein, “large leaf mint leaves” can be considered a type of coarse mint leaves.

### 2. Flavor Compositions

The present application relates to flavor compositions that include ground mint leaves and at least one mint flavor. In certain embodiments, the flavor compositions can be used to provide a cool or mint flavor to a confectionery product, such as a chewing gum. In further embodiments, the flavor compositions are stable over time, have reduced microbial growth, and provide an enhanced flavor and color. In certain embodiments, the levels of microbes in the flavor composition are reduced by at least a 1 log reduction, a 2 log reduction, a 3 log reduction, a 4 log reduction, or a 5 log reduction as compared to the mint leaves alone.

### 2.1 Mint Leaves

The presently disclosed flavor compositions can include mint leaves. The mint leaves can be from a single type of mint plant, or can be a combination of two or more types of plants. For purpose of example, and not limitation, suitable types of mint plants may include any mint plant from the genus Mentha, including, for example, and not limitation, peppermint, spearmint, ginger mint, pineapple mint, woolly mint, pennyroyal, catmint, lavender mint, grapefruit mint, licorice mint, basil mint, watermint, and calamint. In particular embodiments, the mint leaves are from a peppermint plant.

In certain embodiments, the mint leaves can be dried. The mint leaves can be incorporated into the flavor composition in any form, including large leaf, coarse, or ground. In certain embodiments, dried mint leaves are ground prior to incorporation into the flavor composition. In certain embodiments, dried mint leaves are ground to an average particle size of less than 3 mm, or less than 2 mm prior to incorporation into the flavor composition. In certain embodiments, dried mint leaves are ground to an average particle size of from about 1 mm to about 2 mm prior to incorporation into the flavor composition.

As embodied herein, the mint leaves can be present in the flavor composition in an amount of less than 90 wt-%, less than 75 wt-%, less than 60 wt-%, less than 50 wt-%, less than 40 wt-%, less than 30 wt-%, less than 20 wt-%, or less than 10 wt-%. In certain embodiments, the mint leaves can be present in the flavor composition in an amount of from about 1 wt-% to about 90 wt-%, or from about 15 wt-% to about 80 wt-%, or from about 20 wt-% to about 70 wt-%, or from about 25 wt-% to about 60 wt-%.

### 2.2 Mint Flavor

As embodied herein, the flavor composition can further include mint flavor in addition to mint leaves. Although the presence of mint leaves can introduce certain levels of microbes, the use of a mint flavor can provide a micro kill effect to reduce the levels of microbes present in the mint leaves to levels below what is present in the mint leaves alone. For example, the mint flavor can reduce levels of microbes to within acceptable ranges for incorporation into a food product, such as a confectionery product. Additionally, the mint flavor can enhance the sensory characteristics of the mint leaves.

As embodied herein, the mint flavor can include any artificial or natural mint flavors known in the art, for example synthetic flavor oils, natural flavoring aromatics and/or oils, oleoresins, extracts derived from plants, leaves, flowers, fruits, fruit flavors, and the like, or a combination thereof. In certain embodiments, the mint flavor can include one or more, two or more, or three or more mint extracts or oils. For example, and not limitation, suitable mint extracts and oils include menthol, peppermint oil, ginger mint oil, spearmint oil, and oil of wintergreen. Alternatively or additionally, the mint flavor can include cooling compounds and/or other chemicals that add additional mint flavor characteristics.

As embodied herein, the mint flavor can be present in the flavor composition in an amount of greater than 10 wt-%, greater than 20 wt-%, greater than 40 wt-%, greater than 50 wt-%, greater than 60 wt-%, greater than 70 wt-%, greater than 80 wt-%, or greater than 90 wt-%. In certain embodiments, the mint flavor can be present in the flavor composition in an amount of from about 10 wt-% to about 99 wt-%, or from about 15 wt-% to about 95 wt-%, or from about 25 wt-% to about 85 wt-%, or from about 35 wt-% to about 75 wt-%. In certain embodiments, the composition of the flavor composition can be expressed in terms of weight ratios between the amounts of each component. For purpose of example, and not limitation, the weight ratio between the amount of mint flavor and the amount of mint leaves in the flavor composition can range from about 0.5:1 to about 5:1, or from about 1:1 to about 4:1, or from about 1.3:1 to about 3:1, or from about 1.5:1 to about 2.5:1, or from about 1.8:1 to about 2.2:1.

### 2.3. Additional Compounds

In certain embodiments of the disclosed subject matter, the flavor compositions can further include one or more additional compounds. For example, in certain embodiments, the flavor compositions can further include magnolia bark extract (MBE). As embodied herein, and without limitation, the magnolia bark extract can be present in the flavor composition in an amount of less than 25 wt-%, less than 10 wt-%, less than 5 wt-%, less than 3 wt-%, or less than 2 wt-%. For example, and without limitation, the weight ratio between the amount of magnolia bark extract and the amount of mint leaves in the flavor composition can range from about 0.01:1 to about 1:1, or from about 0.015:1 to about 0.5:1, or from about 0.02:1 to about 0.1:1, or from about 0.025:1 to 0.05:1, or from about 0.03:1 to about 0.04:1.

In certain non-limiting embodiments, additional compounds include, but are not limited to, cooling compounds and other chemicals that add additional flavor characteristics. The flavoring agent can be used in liquid or solid form. Flavoring agents may include artificial or natural flavors known in the art, for example synthetic flavor oils, natural flavoring aromatics and/or oils, oleoresins, extracts derived from plants, leaves, flowers, fruits, fruit flavors, and the like, or a combination thereof. Non-limiting representative flavors include oils such as cinnamon oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, or a combination thereof.

Artificial flavor components are also contemplated by the present invention. Those of ordinary skill in the art will recognize that natural and artificial flavors may be combined in any sensorially acceptable blend. All such flavors and blends are contemplated by the presently disclosed subject matter.

### 3. Confectionery Products

The flavor compositions of the presently disclosed subject matter can be used in various edible compositions, including confectionery products such as chewing gums. In certain embodiments, the flavor compositions can impart a mint or cool flavor to the confectionery product. In certain embodiments of the present application, the flavor composition is added to a confectionery product in an amount effective to provide the desired flavor.

In certain embodiments, flavor compositions of the presently disclosed subject matter can be incorporated into confectionery products including, but not limited to, cakes, cookies, pies, candies (hard and soft), compressed mints, chewing gums, gelatins, ice creams, sorbets, jams, jellies, chocolates, fudge, fondant, liquorice, taffy, and combinations thereof.

### 3.1 Chewing Gums

Preferably, the flavor compositions of the presently disclosed subject matter are incorporated into a chewing gum. In certain embodiments, the chewing gum can be in the form of tablets, sticks, solid balls, hollow balls, cut and wrap, and pellets or pillows. Suitable processes for making chewing gum and additional components that may be incorporated into chewing gum are described by way of example in U.S. Pat. No. 8,557,323; U.S. Publication Nos. 2013/0156885 and U.S. 2005/0202118, each of which is incorporated by reference in its entirety herein.

In general, a chewing gum composition typically contains a chewable gum base portion which is essentially free of water and is water-insoluble, a water-soluble bulk portion, and flavors which are typically water insoluble, such as the presently disclosed flavor compositions. The water-soluble portion dissipates with a portion of the flavor over a period of time during chewing. The gum base portion is retained in the mouth throughout the chew.

The insoluble gum base generally comprises any combination of elastomers, elastomer solvents, plasticizers, waxes, emulsifiers, tackifiers, lipids, fillers, including inorganic fillers, and other optional ingredients such as colorants and antioxidants. Plastic polymers, such as polyvinyl acetate, which behave somewhat as plasticizers, can also be included. Other plastic polymers that may be used include polyvinyl laureate, polyvinyl alcohol and polyvinyl pyrrolidone.

As embodied herein, the insoluble gum base can constitute between about 5 wt-% to about 95 wt-% of the chewing gum. More preferably the insoluble gum base comprises between about 10 wt-% and about 50 wt-% of the gum and most preferably between about 20 wt-% and about 35 wt-% of the gum.

Elastomers may include polyisobutylene, butyl rubber, (isobutylene-isoprene copolymer), polyisoprene, polyvinyl acetate, styrene butadiene rubber, vinyl acetate-vinyl laurate copolymer, poly-dl-lactide, glycolic acid-lactide copolymer and styrene butadiene rubber. The elastomer can include one or more natural elastomers, for example, natural rubber such as smoked or liquid latex and guayule, as well as natural gums such as jelutong, lechi caspi, perillo, massaranduba balata, massaranduba chocolate, nispero, rosindinha, chicle, gutta hang kang or mixtures thereof. Elastomer solvents are often resins such as terpene resins and rosin esters.

Plasticizers, sometimes called softeners, are typically fats and oils, including tallow, hydrogenated and partially hydrogenated vegetable oils, and cocoa butter. Commonly employed waxes include paraffin, microcrystalline and natural waxes such as beeswax and carnauba. Microcrystalline waxes, especially those with a high degree of crystallinity, may be considered bodying agents or textural modifiers.

Tackifiers, if present, can include natural rosin esters such as glycerol ester of partially hydrogenated rosin, glycerol ester of polymerized rosin, glycerol ester of partially dimerized rosin, glycerol ester of rosin, pentaerythritol esters of partially hydrogenated rosin, methyl and partially hydrogenated methyl esters of rosin, pentaerythritol ester of rosin or mixtures; synthetic resins such as terpene resins derived from alpha-pinene, beta-pinene and/or d-limonene, polyvinyl acetate resin, polyethylene, and poly-dl-lactide resin.

Lipids, if present, can include mono-, and/or di-, and/or tri-glycerides of alkanoic acids, or of monoenoic acids or of polyunsaturated fatty acids with carbon chain length from C4 to C24 or a mixture thereof, hydrogenated and partially hydrogenated mono-, and/or di-, and/or tri-glycerides of monoenoic acid and of polyunsaturated fatty acids, acetylated glycerides of fatty acids, lecithin, paraffin wax, and microcrystalline and natural waxes such as beeswax and carnauba.

The gum base typically also includes a filler component. The filler component may be calcium carbonate, magnesium carbonate, talc, dicalcium phosphate or the like. The filler may constitute between about 5 wt-% and about 60 wt-% of the gum base. Preferably the filler comprises from about 5 wt-% to about 50 wt-% of the gum base. In certain embodiments, fillers include, but are not limited to, magnesium and calcium carbonate, ground limestone and silicate types such as magnesium and aluminum silicate, clay, alumina, talc as well as titanium oxide, mono-, di- and tricalcium phosphate, cellulose polymers such as ethyl, methyl and wood or mixtures thereof, and combinations thereof.

Gum bases can also contain softeners including glycerin, lecithin, glycerol monostearate, and glycerol triacetate. In certain embodiments, humectants are added to the chewing gum in order to optimize the chewability and mouth feel of the gum. Further, aqueous sweetener solutions such as those containing sorbitol, hydrogenated starch hydrolysates, corn syrup and combinations thereof can be used as softeners and binding agents in chewing gum formulations. Gum bases can also contain optional ingredients such as antioxidants, colors, and emulsifiers. The present invention contemplates employing any commercially acceptable gum base.

The water-soluble portion of the chewing gum can comprise softeners, sweeteners, flavoring agents (including sensates such as physiological cooling agents, warming agents and tingling agents), high-intensity sweeteners, colorants, humectants, gum emulsifiers, acidulants, binders, fillers, cooling agents and combinations thereof. The sweeteners often fulfill the role of bulking agents in the gum. Bulk sweeteners can include both sugars and sugar alcohols. The bulking agents typically comprise about 5% to about 95% of the gum composition.

The presently disclosed flavor compositions can be used in sugar and sugarless gum formulations. Sugar sweeteners generally include saccharide-containing components commonly known in the chewing gum art which comprise, but are not limited to, sucrose, dextrose, maltose, dextrin, dried invert sugar, fructose, galactose, corn syrup solids and the like, alone or in any combination. Sugarless sweeteners include components with sweetening characteristics but which are devoid of the commonly known sugars and comprise, but are not limited to, sugar alcohols such as sorbitol, hydrogenated isomaltulose, mannitol, xylitol, lactitol, erythritol, hydrogenated starch hydrolysate, maltitol and the like alone or in any combination.

In some embodiments, the chewing gum ingredients can include one or more high intensity sweeteners. As used herein, the term “high intensity sweetener” refers to any substance that is at least twenty times sweeter than sucrose. Such sweeteners include, but are not limited to, saccharin, cyclamate, aspartame, alitame, neotame, other peptide-based sweeteners, sucralose, acesulfame K, stevia (including purified extracts such as rebaudioside A), glycyrrhizin, neohesperidin dihydrochalcone and mixtures thereof. In some embodiments, at least a portion of the high intensity sweetener will be encapsulated. Such encapsulations may be produced by granulation, agglomeration, extrusion and grinding, spray drying, fluid bed encapsulation or any other known means. In certain embodiments, suitable sugar alcohols include sorbitol, mannitol, xylitol, hydrogenated starch hydrolysates, maltitol, and the like, as well as combinations thereof. In certain embodiments, the sugarless gum comprises a combination of a high-potency sweetener with a sugar alcohol, e.g., aspartame and sorbitol. Usage levels will depend on the potency of the sweetener, degree and effectiveness of the encapsulation (if any) as well as the sensory profile desired for the product. Generally, the sweetener can be used at levels as low as 0.005 wt-%, or as low as 0.05 wt-%, or as low as 0.2 wt-%, to as high as 5 wt-%, or as high as 3 wt-%, or as high as 2 wt-% in the chewing gum composition. In some embodiments, the high intensity sweetener will be present at a level of from about 0.1 wt-% to about 1.0 wt-% of the chewing gum ingredients.

In certain embodiments, the presently disclosed flavor composition comprising mint leaves and mint flavor can be added to the chewing gum in amounts of from about 0.01 wt-% to about 20 wt-% of the gum, or from about 0.05 wt-% to about 10 wt-% of the gum, or from about 0.1 wt-% to about 5 wt-% of the gum, and preferably, from about 0.2 wt-% to about 10 wt-% by weight, or from about 0.5 wt-% to about 7 wt-% of the total weight of the chewing gum.

In certain embodiments, a variety of additional flavoring agents can also be used, if desired. Flavoring agents may include essential oils and extracts, synthetic flavors or mixtures thereof including, but not limited to, oils and extracts derived from plants and fruits such as citrus oils, fruit essences, clove oil, anise, and the like. Artificial flavoring agents and components may also be used. Natural and artificial flavoring agents may be combined in any sensorially acceptable fashion. Included in the general category of flavors are sensates, chemicals which impart physiological sensations in the mouth such as cooling agents, warming agents and tingling agents. Examples of cooling agents include menthol, WS-23, WS-3, WS-5, isopulegol, esters of menthol such as menthyl succinate, menthyl lactate and menthyl glutarate, among others. Warming and tingling agents include capsaicin, piperine, jambu and spilanthol.

Optional ingredients such as colorants, whiteners, antioxidants, emulsifiers and pharmaceutical agents may also be added as separate components of the chewing gum composition, or added as part of the gum base. In certain embodiments, the colors and whiteners can include, but are not limited to, FD&C-type dyes and lakes, fruit and vegetable extracts, titanium dioxide or mixtures thereof. In certain embodiments, the antioxidants can include, but are not limited to, beta-carotenes, acidulants (e.g. Vitamin C), alpha-tocopherol (vitamin E), beta, gamma and delta tocopherols, propyl gallate, butylated hydroxyanisole (BHA), butylated hydroxytoluene (BHT) and tertiary butyl hydroquinone (TBHQ). In specific embodiments, the gum base includes optional minor amounts (about one percent or less) of miscellaneous ingredients such as colorants, antioxidants, etc.

### 3.1.1 Methods of Making

As embodied herein, a method of manufacturing chewing gum according to the present disclosure is by sequentially adding the various chewing gum ingredients to any commercially available mixer known in the art. After the ingredients have been thoroughly mixed, the gum is discharged from the mixer and shaped into the desired form such as by rolling into sheets and cutting into sticks, extruding into chunks, or casting into pellets.

Generally, the ingredients are mixed by first melting the gum base and adding it to the running mixer. The base may also be melted in the mixer itself. Color or emulsifiers may also be added at this time, along with syrup and a portion of the bulking agent. Further portions of the bulking agent may then be added to the mixer. A flavoring agent can be added with the final portion of the bulking agent. The flavor composition can then be added. The entire mixing procedure typically takes from five to twenty minutes, but longer mixing times may sometimes be required. Those skilled in the art will recognize that many variations of the above described procedures may be followed.

In certain embodiments, the flavor composition can be pre-blended prior to addition to the chewing gum mixture. For example, the mint leaves and mint flavor, along with additional components, if any, in the flavor composition can be mixed together before being added to the chewing gum mixture. In certain embodiments, the flavor composition can be aged prior to being added to the chewing gum mixture. For example, the flavor composition can be aged for at least 1 day, at least 5 days, at least 7 days, at least 10 days, at least 14 days, or longer. Additionally or alternatively, the flavor composition can be treated with heat prior to incorporation into the chewing gum. For example, in certain embodiments, the flavor composition can be maintained at a certain temperature, e.g., from about 40° C. to about 60° C., or about 50° C., for a certain period of time, e.g., from about 15 minutes to 1 hour, or about 30 minutes. Aging and/or heat treatment of the flavor composition can improve its micro kill effect.

As embodied herein, if formed into pellets or balls, the chewing gum composition can be coated. The coating is initially present as a liquid syrup which contains from about 30% to about 80% or 85% sugars or sugar alcohols, and from about 15% or 20% to about 70% of a solvent such as water. In general, the coating process is carried out in conventional panning equipment. Gum center tablets to be coated are placed into the panning equipment to form a moving mass.

The material or syrup which will eventually form the coating is applied or distributed over the gum center tablets. Flavors may be added before, during and after applying the syrup to the gum centers. Once the coating has dried to form a hard surface, additional syrup additions can be made to produce a plurality of coatings or multiple layers of coating.

In the panning procedure, syrup is added to the gum center tablets at a temperature range of from about 100° F. to about 240° F. Preferably, the syrup temperature is from about 140° F. to about 200° F. Most preferably, the syrup temperature should be kept constant throughout the process in order to prevent the polyol in the syrup from crystallizing. The syrup may be mixed with, sprayed upon, poured over, or added to the gum center tablets in any way known to those skilled in the art.

In another embodiment, a soft coating is formed by adding a powder coating after a liquid coating. The powder coating may include natural carbohydrate gum hydrolysates, maltodextrin, gelatin, cellulose derivatives, starches, modified starches, sugars, sugar alcohols, natural carbohydrate gums and fillers like talc and calcium carbonate.

Each component of the coating on the gum center may be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats may be applied to the gum center tablet. Preferably, no more than about 75 coats are applied to the gum center. More preferably, less than about 60 coats are applied and most preferably, about 30 to about 60 coats are applied. In any event, the present invention contemplates applying an amount of syrup sufficient to yield a coated chewing gum product containing about 10% to about 65% coating. Preferably, the final product will contain from about 20% to about 50% coating.

Those skilled in the art will recognize that in order to obtain a plurality of coated layers, a plurality of premeasured aliquots of coating syrup may be applied to the gum center. It is contemplated, however, that the volume of aliquots of syrup applied to the gum center may vary throughout the coating procedure.

Once a coating of syrup is applied to the gum center, the syrup is dried in an inert medium. A preferred drying medium comprises air. Preferably, forced drying air contacts the wet syrup coating in a temperature range of from about 70° F. to about 110° F. More preferably, the drying air is in the temperature range of from about 80° F. to about 100° F. The invention also contemplates that the drying air possesses a relative humidity of less than about 15 percent. Preferably, the relative humidity of the drying air is less than about 8 percent.

The drying air may be passed over and admixed with the syrup coated gum centers in any way commonly known in the art. Preferably, the drying air is blown over and around the syrup coated gum center. If a flavor is applied after a syrup coating has been dried, the present invention contemplates drying the flavor with or without the use of a drying medium.

In certain embodiments, upon manufacturing the chewing gum, the chewing gum is maintained in a low moisture and/or low light environment. In certain embodiments, the water activity of the chewing gum is maintained below about 0.85. In certain embodiments, the water activity can be mitigated by using a low amount of glycerol in the chewing gum. For example, and not limitation, in certain embodiments the chewing gum can include from about 0.25 wt-% to about 1 wt-%, and preferably from about 0.5 wt-% to about 0.7 wt-% glycerol. In certain embodiments, the amount of glycerol can be further reduced by including additional syrup and/or sweetener components. Additionally or alternatively, the chewing gum can be appropriately packaged as known in the art to reduce exposure to moisture and/or light. As embodied herein, reducing exposure to moisture and/or light can improve the flavor and color stability of the chewing gum, and increase the shelf life of the chewing gum.

### 3.1.2 Micro Kill Effect

In certain embodiments, a flavor composition comprising mint leaves and a mint flavor can have decreased levels of microbes as compared to the mint leaves alone, and can also reduce the levels of microbes in a chewing gum including the flavor composition. For example, in certain embodiments, the chewing gum can have less than about 250 cfu/g of mold and/or less than about 250 cfu/g of yeast. In certain embodiments, the chewing gum can have less than about 25,000 cfu/g of aerobic plate count (APC). The chewing gum can have less than about 50 MPN/g total coliforms. The chewing gum can have less than about <3 MPN/g of E. coli. Additionally or alternatively, a 375 g sample of the chewing gum can have no detectable amount of salmonella.

As embodied herein, levels of microbes can be measured using any suitable method, as known in the art. For example, in certain embodiments, levels of microbes can be measured using methods based on the FDA's Bacteriological Analytical Manual (BAM). In certain embodiments, aerobic plate count (APC) can be measured according to BAM, Chapter 3. In certain embodiments, E. coli and/or coliforms levels can be measured according to BAM, Chapter 4. In certain embodiments, salmonella levels can be measured according to BAM, Chapter 5. In certain embodiments, mold and/or yeast levels can be measured according to BAM, Chapter 18.

In certain embodiments, it is desirable to reduce the levels of microbes in the flavor composition, e.g., a flavor composition comprising mint leaves and a mint flavor, as compared to the mint leaves alone. For example, in certain embodiments, the levels of microbes in the mint leaves are reduced by at least a 1 log reduction, a 2 log reduction, a 3 log reduction, a 4 log reduction, or a 5 log reduction by the addition of a mint flavor. Alternatively or additionally, the levels of microbes in a chewing gum including the flavor composition can be reduced below certain levels. For example, the levels of microbes in the chewing gum can be less than about 250 cfu/g of mold and/or less than about 250 cfu/g of yeast and/or less than about 25,000 cfu/g of aerobic plate count (APC) and/or less than about 50 MPN/g total coliforms and/or less than about <3 MPN/g of E. coli and/or a 375 g sample of the chewing gum can have no detectable amount of salmonella. In certain embodiments, the micro kill of the presently disclosed flavor composition can be comparable or improved as compared to certain methods of reducing microbe levels as known in the art, for example, chemical treatment (e.g., with solvents, acids, and the like), heat treatment (e.g., with time and temperature), radiation treatment (e.g., including medium- and high-dose applications of about 10 kGy), and pressure treatment.

Thus, the chewing gums of the present disclosure can safely incorporate plant matter, such as mint leaves, while having enhanced and stable flavor and visual appearance.

### EXAMPLES

The presently disclosed subject matter will be better understood by reference to the following Examples, which are provided as exemplary of the disclosed subject matter, and not by way of limitation.

### Example 1: Micro Testing of Flavor Compositions and Gum Formulations Containing Mint Leaves

In this Example, seven gum formulations, each containing different flavor compositions, as well as two flavor compositions were tested for microbial growth to determine the effect of the flavor compositions on microbial growth. Some flavor compositions included mint flavors (e.g., natural menthol and peppermint oil), while others contained triacetin.

Seven gums were formulated, having the compositions shown in Table 1, below:

TABLE 1
Compositions of Gum Formulations 1A-1G (amounts in wt-%).

| Ingredient | 1A | 1B | 1C | 1D | 1E | 1F | 1G |
|---|---|---|---|---|---|---|---|
| Sugar | 66.3 | 66.3 | 66.3 | 66.3 | 66.3 | 66.3 | 66.3 |
| Base | 30 | 30 | 30 | 30 | 30 | 30 | 30 |
| Mint Flavors | 2.4 | 2.4 | 2.4 | — | — | — | — |
| Triacetin | — | — | — | 2.4 | 2.4 | 2.4 | 2.4 |
| Glycerin | 0.3 | 0.3 | 0.3 | 0.3 | 0.3 | 0.3 | 0.3 |
| Coarse mint leaves/ | 1 | — | — | — | — | — | — |
| not pre-blended with | | | | | | | |
| mint flavor | | | | | | | |
| Ground mint leaves/ | — | 1 | — | — | — | — | — |
| pre-blended with mint | | | | | | | |
| flavor to a paste | | | | | | | |
| Ground mint leaves/ | — | — | 1 | — | — | — | — |
| not pre-blended with | | | | | | | |
| mint flavor | | | | | | | |
| Coarse mint leaves/ | — | — | — | 1 | — | — | — |
| not pre-blended with | | | | | | | |
| triacetin | | | | | | | |
| Ground mint leaves/ | — | — | — | — | 1 | — | — |
| not pre-blended with | | | | | | | |
| triacetin | | | | | | | |
| Ground mint leaves/ | — | — | — | — | — | 1 | — |
| pre-blended with | | | | | | | |
| triacetin to a paste | | | | | | | |
| Large leaf peppermint/ | — | — | — | — | — | — | 1 |
| not pre-blended with | | | | | | | |
| triacetin | | | | | | | |

As shown in Table 1, Formulations 1A-1C included mint leaves and mint flavors. Formulations 1D-1G included mint leaves and triacetin. In Formulations 1A-1F, the mint leaves were sourced from Core Botanica and were coarsely broken. In Formulations 1B, 1C, 1E, and 1F, the coarsely broken leaves were further ground twice on a Turkish Grind. In Formulations 1B and 1F, the ground mint leaves were pre-blended with the mint flavor (Formulation 1B) or triacetin (Formulation 1F) prior to incorporation into the gum formulation. Formulation 1G included large leaf peppermint sourced from Core Botanica rather than coarse or ground mint leaves.

For the gum formulations containing pre-blended mint leaves and mint flavor/triacetin (i.e., Formulations 1B and 1F), the blends were made one day prior to incorporation into the gum formulation. Blend 1B included mint flavor and ground mint leaves in the ratio shown in Table 1 above for Formulation 1B. Similarly, Blend 1F included triacetin and ground mint leaves in the ratio shown for Formulation 1F.

These blends, as well as the seven gum formulations, were tested for microbial growth. The samples were not aged prior to testing. Each sample was tested for mold, yeast, aerobic plate count (APC), coliforms, E. coli, and salmonella. In this and subsequent examples, the micro testing was carried out using the methods described in the FDA's Bacteriological Analytical Manual (BAM). APC was measured according to BAM, Chapter 3. E. coli and coliforms levels were measured according to BAM, Chapter 4. Salmonella levels were measured according to BAM, Chapter 5. Mold and yeast levels were measured according to BAM, Chapter 18. Table 2 provides the results of the micro testing as compared to a control containing mint leaves only (coarse mint leaves sourced from Core Botanica).

TABLE 2
Micro Testing of Gum Formulations 1A-1G, Flavor Blends
1B and 1F, and Control (course mint leaves)

| | Mold | Yeast | APC | Coliforms | E. coli | Salmonella |
|---|---|---|---|---|---|---|
| Sample | (est. cfu/g) | (est. cfu/g) | (cfu/g) | (MPN/g) | (MPN/g) | (result/375 g) |
| Formulation 1A | <10 | 330 | 3700 | <3 | <3 | Negative |
| (containing course mint | | | | | | |
| leaves, not pre-blended | | | | | | |
| with mint flavor) | | | | | | |
| Formulation 1B | 10 | 30 | 8100 | <3 | <3 | Negative |
| (containing ground mint | | | | | | |
| leaves pre-blended with | | | | | | |
| mint flavor) | | | | | | |
| Formulation 1C | <10 | 30 | 1300 | <3 | <3 | Negative |
| (containing ground mint | | | | | | |
| leaves, not pre-blended | | | | | | |
| with mint flavor) | | | | | | |
| Formulation 1D | <10 | 420 | 5400 | <3 | <3 | Negative |
| (containing course mint | | | | | | |
| leaves, not pre-blended | | | | | | |
| with triacetin) | | | | | | |
| Formulation 1E | 260 | 40 | 8300 | <3 | <3 | Negative |
| (containing ground mint | | | | | | |
| leaves, not pre-blended | | | | | | |
| with triacetin) | | | | | | |
| Formulation 1F | 380 | 20 | 7500 | <3 | <3 | Negative |
| (containing ground mint | | | | | | |
| leaves, pre-blended | | | | | | |
| with triacetin) | | | | | | |
| Formulation 1G | 50 | 60 | 870 | <3 | <3 | Negative |
| (containing large leaf | | | | | | |
| mint leaves, not pre- | | | | | | |
| blended with triacetin) | | | | | | |
| Blend 1B | 3900 | <10 | 4700 | <3 | <3 | Negative |
| (mint leaves plus | | | | | | |
| mint flavor blend) | | | | | | |
| Blend 1F | 7300 | 1200 | 52000 | 240 | <3 | Negative |
| (mint leaves plus | | | | | | |
| triacetin blend) | | | | | | |
| Control (coarse | 18000 | 43000 | 83000 | 1100 | <3 | Negative |
| mint leaves) | | | | | | |

For each of mold and yeast, it is generally desirable to maintain levels below 250 cfu/g. Similarly, it is desirable to maintain levels below 25,000 cfu/g for APC and below 50 MPN/g for coliforms. For E. coli, it is desirable to have no measurable amount (e.g., <3 MPN/g). For salmonella, it is desirable to detect no microbes in a 375 g sample (i.e., be negative for salmonella within a 375 g sample).

The dried mint leaves alone (i.e., the control) had results indicating that high mold, yeast, APC, and coliform were present in the dried leaf material. As shown in Table 2, gum formulations with ground mint leaf demonstrated overall lower microbe levels than formulations with coarse or large leaf mint leaves (i.e., Formulas 1A, 1D, and 1G), particularly with respect to yeast levels. Additionally, the formulations and blends containing mint flavor had improved micro kill effect as compared to those containing triacetin and the control. For example, blending leaves with mint flavor reduced mold and APC by 1 log, and reduced coliforms by 3 log, as compared to the control. Moreover, levels of yeast were dramatically reduced as compared to the control. Although triacetin also reduced mold and coliforms, mint flavor was found to have a better micro kill effect.

Moreover, it was found that incorporating a blend into a gum formulation can improve micro kill effect as compared to the blend alone. For example, Formulation 1B (which incorporated Blend 1B) had a better micro kill effect as compared to Blend 1B alone (which combined mint leaves and mint flavor), and particularly, had a decreased amount of observed mold. Regardless, gum formulations with pre-blended or separately added mint flavor and mint leaves consistently showed improved micro kill, suggesting that stable gum formulations can be made including mint leaves with mint flavor, and without the use of triacetin.

### Example 2: Sensory Testing of Gum Formulations

In this Example, sensory observations, including visual, smell, and taste perceptions, of Formulations 1A-1G of Example 1, were collected.

Three tasters tasted and smelled each of Gum Formulations 1A-1G and recorded their observations in real time. These observations are summarized in Table 3:

TABLE 3
Taste and Odor Perceptions of Gum Formulations 1A-1G.

| Sample | Taster 1 | Taster 2 | Taster 3 |
|---|---|---|---|
| Formulation | mentholic | sour notes | Mint field |
| 1A | odor with | in odor; | distillation |
| | green notes; | initial dry | off-odor; |
| | not as | leaf note in | okay taste, |
| | clean taste | taste | high flavor |
| Formulation | peppermint odor; | no offensive | good odor; |
| 1B | very good | odor or dry | good flavor |
| | mint taste | leaf smell; | |
| | | very good | |
| | | mint taste | |
| Formulation | acceptable odor | unusual | good odor; was |
| 1C | and taste | hay note; | rougher but okay |
| | | acceptable | |
| Formulation | off odor; | off odor; | odor off; |
| 1D | slight dry | dry leaf | flavor very |
| | leaf note | note | slightly cool |
| | in chew | | |
| Formulations | none | all had dry | off odor; |
| 1E, 1F, and 1G | | leaf notes | skunky off |
| | | | odor |

Based on the observations summarized in Table 3, it appears that the gum formulation in which the mint leaves and mint flavor were pre-blended (i.e., Formulation 1B) had improved odor and taste as compared to those where the ingredients were added separately (i.e., Formulations 1A and 1C). Additionally, Formulation 1B had improved odor and taste as compared to the formulations containing triacetin (i.e., Formulations 1D-1G). Moreover, those with ground or coarse leaves generally were perceived as having a better odor than the large leaf formulation (i.e., Formulation G). Accordingly, flavor compositions with both mint leaves and mint flavor generally had improved taste and odor. Additionally, these data suggest that flavor can be enhanced by grinding the mint leaves and/or by pre-blending the mint leaves and mint flavor prior to incorporation in a gum formulation.

Additionally, four gum formulations (Formulations 1A, 1B, 1C, and 1F) were tested over a 23 day period to observe color stability. Samples of each of the formulations were placed in a window and exposed to light for the duration of the test, while other samples were kept in the dark. At the conclusion of the time period, the colors were observed between the sets of samples. Each of the samples remained very green when protected from light, but when exposed to light, each sample lost its green hue, and became grayer and darker.

### Example 3: Micro Testing of Flavor Compositions after Aging and Heat Treatment

In this Example, six flavor compositions, each containing mint leaves, were aged and tested for microbial growth. Three flavor compositions included mint flavor and three included triacetin. One flavor composition with triacetin further include magnolia bark extract (MBE). The flavor compositions were aged and/or heat treated. The flavor compositions and aging/heat treatment details are summarized in Table 4 below:

TABLE 4
Compositions of Flavor Blends 3A-3F (g, wt-%).

| Ingredient | 3A | 3B | 3C | 3D | 3E | 3F |
|---|---|---|---|---|---|---|
| Mint Flavor | 141.18, | 141.18, | — | — | 141.18, | — |
| | 71% | 71% | | | 71% | |
| Triacetin | — | — | 141.18, | 141.18, | — | 139.18, |
| | | | 71% | 71% | | 70% |
| Ground Mint | 58.82, | 58.82, | 58.82, | 58.82, | 58.82, | 58.82, |
| Leaves | 29% | 29% | 29% | 29% | 29% | 29% |
| Magnolia | — | — | — | — | — | 2, |
| Bark Extract | | | | | | 1% |
| Treatment | Aged 1 | Aged 2 | Aged 1 | Aged 2 | Aged 1 | Aged 1 |
| | week | weeks | week | weeks | week & | week |
| | | | | | heat | |
| | | | | | treated | |

The ground mint leaves of each of Flavor Blends 3A-3F were Peppermint leaves sourced from Core Botanica, and ground once on a Turkish Grind. Blend 3E was heat treated at 50° C. for 30 minutes prior to aging. Additionally, a control was prepared with 200 g of the same ground mint leaves. Each sample was tested for microbial growth, including for mold, yeast, aerobic plate count (APC), coliforms, E. coli, and salmonella. Table 5 provides the results of the micro testing as compared to the control.

TABLE 5
Micro Testing of Flavor Blends 3A-3F and Control

| | Mold | Yeast | APC | Coliforms | E. coli | Salmonella |
|---|---|---|---|---|---|---|
| Sample | (est. cfu/g) | (est. cfu/g) | (cfu/g) | (MPN/g) | (MPN/g) | (result/375 g) |
| Blend 3A | 900 | <10 | 4500 | <3 | <3 | Negative |
| Blend 3B | 800 | <10 | 2400 | <3 | <3 | Negative |
| Blend 3C | 10000 | <10 | 54000 | 43 | <3 | Negative |
| Blend 3D | 9600 | <10 | 23000 | <3 | <3 | Negative |
| Blend 3E | 900 | <10 | 2600 | <3 | <3 | Negative |
| Blend 3F | <10 | <10 | 3000 | <3 | <3 | Negative |
| Control (ground | 14000 | <10 | 220000 | >1100 | <3 | Negative |
| mint leaves) | | | | | | |

Combining mint leaves with mint flavor was found to improve micro kill as compared to the control. Heat treatment, as in Blend 3E, decreased APC, although the other samples including mint flavor (Blends 3A and 3B) also had decreased levels of APC. Aging generally improved micro kill as well (for example, as compared to Example 1). Blends 3A, 3B, and 3E had improved micro kill as compared to the sample containing only triacetin (Blends 3C and 3D), although the presence of magnolia bark extract also appears to improve micro kill. Moreover, as demonstrated in Example 1, incorporating blends into a gum formulation further improved micro kill, so Blends 3A, 3B, and 3E would be expected to achieve even better micro kill when included into a chewing gum.

### Example 4: Effect of Magnolia Bark Extract (MBE) on Micro Kill

In this Example, five flavor compositions, each containing mint leaves and magnolia bark extract, were aged and tested for microbial growth. One flavor composition included mint flavor (i.e., natural peppermint oil and/or menthol) and the other four included triacetin. The flavor compositions are summarized in Table 6 below:

TABLE 6
Compositions of Flavor Blends 4A-4E (g, wt-%).

| Ingredient | 4A | 4B | 4C | 4D | 4E |
|---|---|---|---|---|---|
| Mint Flavor | — | — | — | — | 139.18, |
| | | | | | 69.59% |
| Triacetin | 138.18, | 139.18, | 140.18, | 140.68, | — |
| | 69.09% | 69.59% | 70.09% | 70.34% | |
| Ground Mint Leaves | 58.82, | 58.82, | 58.82, | 58.82, | 58.82, |
| | 29.41% | 29.41% | 29.41% | 29.41% | 29.41% |
| Magnolia Bark | 3.00, | 2.00, | 1.00, | 0.50, | 2.00, |
| Extract (MBE) | 1.50% | 1.00% | 0.50% | 0.25% | 1.00% |
| Aging | 1 week | 1 week | 1 week | 1 week | 1 week |

The ground mint leaves of each of Blends 4A-4E were Large Leaf Peppermint sourced from Core Botanica, and ground once on a Turkish Grind. Additionally, a control (Control 4B) was prepared with 200 g of the same ground large leaf mint leaves. A second control (Control 4A) was prepared with 200 g of coarsely broken peppermint leaves sourced from Core Botanica, ground once on a Turkish Grind. Micro testing was performed on each of Flavor Blends 4A-4E as well as Controls 4A and 4B, as summarized in Table 7, below.

After aging, each of Blends 4A-4E was tested for microbial growth, including for mold, yeast, aerobic plate count (APC), coliforms, E. coli, and salmonella, and compared to Controls 4A and 4B. Table 7 provides the results of the micro testing as compared to the control.

TABLE 7
Micro Testing of Flavor Blends 4A-4E and Ground Mint Leaf Controls 4A-4B

| | Mold | Yeast | APC | Coliforms | E. coli | Salmonella |
|---|---|---|---|---|---|---|
| Sample | (est. cfu/g) | (est. cfu/g) | (cfu/g) | (MPN/g) | (MPN/g) | (result/375 g) |
| Flavor Blend 4A | <10 | 1500 | 82000 | 150 | <3 | Negative |
| (containing | | | | | | |
| ground mint | | | | | | |
| leaves, MBE, | | | | | | |
| and triacetin) | | | | | | |
| Flavor Blend 4B | 1200 | <10 | 91000 | 1100 | <3 | Negative |
| (containing | | | | | | |
| ground mint | | | | | | |
| leaves, MBE, | | | | | | |
| and triacetin) | | | | | | |
| Flavor Blend 4C | 2900 | <10 | 88000 | 3 | <3 | Negative |
| (containing | | | | | | |
| ground mint | | | | | | |
| leaves, MBE, | | | | | | |
| and triacetin) | | | | | | |
| Flavor Blend 4D | 10000 | <10 | 72000 | 1100 | <3 | Negative |
| (containing | | | | | | |
| ground mint | | | | | | |
| leaves, MBE, | | | | | | |
| and triacetin) | | | | | | |
| Flavor Blend 4E | 2500 | <10 | 2200 | <3 | <3 | Negative |
| (containing | | | | | | |
| ground mint | | | | | | |
| leaves, MBE, | | | | | | |
| and mint flavor) | | | | | | |
| Control 4A | 7100 | 2900 | 120000 | 1100 | <3 | Negative |
| (ground coarse | | | | | | |
| leaf mint leaves | | | | | | |
| only) | | | | | | |
| Control 4B | 5900 | 2500 | >570000 | >1100 | <3 | Negative |
| (ground large leaf | | | | | | |
| mint leaves only) | | | | | | |

The ground dried mint leaves (i.e., the controls), whether large leaf or coarse, when tested for micro kill, had results indicating high mold, yeast, and APC. None of the leaves tested positive for E. coli or salmonella. Incorporation of magnolia bark extract with mint leaves generally improved micro kill as compared to the controls. However, the best results were achieved with Blend 4E, which combined mint flavor, magnolia bark extract, and mint leaves. Therefore, a combination of mint flavor and magnolia bark extract can be used to create stable mint leaf flavor compositions without the use of triacetin.

### Example 5: Micro Testing of Gum Formulations and Flavor Compositions

In this Example, seven gum formulations, each containing different flavor compositions, and six flavor compositions were tested for microbial growth. As a control, one gum formulation did not include mint leaves. The remaining gum formulations included mint leaves with various combinations of mint flavors, magnolia bark extract, and triacetin. The gum formulations are summarized in Table 8 below:

TABLE 8
Compositions of Gum Formulations 5A-5G (wt-%).

| Ingredient | 5A | 5B | 5C | 5D | 5E | 5F | 5G |
|---|---|---|---|---|---|---|---|
| Sugar | 70 | 68.968 | 67.968 | 68.118 | 67.868 | 67.468 | 67.868 |
| Gum Base | 28 | 28 | 28 | 28 | 28 | 28 | 28 |
| Glycerin | 0.6 | 0.6 | 0.6 | 0.6 | 0.6 | 0.6 | 0.6 |
| Emulsifier | 0.3 | 0.3 | 0.3 | 0.3 | 0.3 | 0.3 | 0.3 |
| Medium Chain | — | — | — | 0.15 | — | — | — |
| Triglycerides | | | | | | | |
| Flavor | — | — | — | — | — | 0.5 | — |
| Triacetin | 0.44 | 0.44 | 0.44 | — | — | — | — |
| Mint Flavor | — | — | — | 1.8 | 2.2 | 2.1 | 1.95 |
| Ground mint leaves | — | 1 | 2 | 1 | 1 | 1 | 1 |
| Medium Chain | 0.66 | 0.66 | 0.66 | — | — | — | — |
| Triglycerides | | | | | | | |
| Magnolia Bark | — | 0.032 | 0.032 | 0.032 | 0.032 | 0.032 | 0.032 |
| Extract | | | | | | | |
| Ginger Mint Oil | — | — | — | — | — | — | 0.25 |

The ground mint leaves were pre-blended with the following ingredients, if present: triacetin, mint flavor, medium chain triglycerides, magnolia bark extract, and ginger mint oil. The ground mint leaves used in both the gum formulations and flavor compositions were from Core Botanica Large Leaf Mint Leaves, ground once on a Turkish Grind. The flavor compositions are summarized in Table 9 below:

TABLE 9
Compositions of Flavor Blends 5A-5G (wt-%).

| Ingredient | 5A | 5B | 5C | 5D | 5E | 5F | 5G |
|---|---|---|---|---|---|---|---|
| Triacetin | 40 | 20.64 | 14.05 | — | — | — | — |
| Mint Flavor | — | — | — | 63.56 | 68.07 | 67.05 | 60.33 |
| Ground mint leaves | — | 46.90 | 63.86 | 35.31 | 30.94 | 31.93 | 30.94 |
| Medium Chain | 60 | 30.96 | 21.07 | — | — | — | — |
| Triglycerides (MCT) | | | | | | | |
| Magnolia Bark | — | 1.50 | 1.02 | 1.13 | 0.99 | 1.02 | 0.99 |
| Extract (MBE) | | | | | | | |
| Ginger Mint Oil | — | — | — | — | — | — | 7.74 |

The ground mint leaves of each of Gum Formulations 5A-5G and Flavor Blends 5A-5G were Large Leaf Peppermint sourced from Core Botanica, and ground once on a Turkish Grind. The ground mint leaves of this Example were the same lot as those of Controls 4A and 4B of Example 4.

Without aging, each of Gum Formulations 5A-5G and Flavor Blends 5B-5G was tested for microbial growth, including for mold, yeast, aerobic plate count (APC), coliforms, E. coli, and salmonella. Blend 5A was not tested for microbial growth as it did not contain mint leaves. Table 10 provides the results of the micro testing as compared to the control.

TABLE 10
Micro Testing of Gum Formulations 5A-5G, Flavor Blends
5B-5G, and Ground Mint Leaf Controls 4A and 4B

| | Mold | Yeast | APC | Coliforms | E. coli | Salmonella |
|---|---|---|---|---|---|---|
| Sample | (est. cfu/g) | (est. cfu/g) | (cfu/g) | (MPN/g) | (MPN/g) | (result/375 g) |
| Formulation 5A | <10 | <10 | <10 | <3 | <3 | Negative |
| (containing triacetin | | | | | | |
| and MCT) | | | | | | |
| Formulation 5B | 500 | <10 | <10 | <3 | <3 | Negative |
| (containing triacetin, | | | | | | |
| mint leaves, MCT, and | | | | | | |
| MBE) | | | | | | |
| Formulation 5C | <10 | <10 | 400 | <3 | <3 | Negative |
| (containing triacetin, | | | | | | |
| mint leaves, MCT, and | | | | | | |
| MBE) | | | | | | |
| Formulation 5D | <10 | <10 | 20 | <3 | <3 | Negative |
| (containing mint | | | | | | |
| flavor, mint leaves, | | | | | | |
| and MBE) | | | | | | |
| Formulation 5E | <10 | <10 | 1100 | <3 | <3 | Negative |
| (containing mint | | | | | | |
| flavor, mint leaves, | | | | | | |
| and MBE) | | | | | | |
| Formulation 5F | <10 | <10 | 490 | <3 | <3 | Negative |
| (containing mint | | | | | | |
| flavor, mint leaves, | | | | | | |
| and MBE) | | | | | | |
| Formulation 5G | 10 | <10 | <10 | <3 | <3 | Negative |
| (containing mint | | | | | | |
| flavor, mint leaves, | | | | | | |
| ginger mint oil, and | | | | | | |
| MBE) | | | | | | |
| Blend 5A | Not Tested | | | | | |
| Blend 5B | 15000 | 3100 | 100000 | >1100 | <3 | Negative |
| Blend 5C | 16000 | 3100 | 150000 | 43 | <3 | Negative |
| Blend 5D | 2700 | <10 | 1100 | <3 | <3 | Negative |
| Blend 5E | 3800 | <10 | 2300 | <3 | <3 | Negative |
| Blend 5F | 3700 | <10 | 1800 | <3 | <3 | Negative |
| Blend 5G | 2800 | <10 | 1300 | <3 | <3 | Negative |
| Control 4A | 7100 | 2900 | 120000 | 1100 | <3 | Negative |
| Control 4B | 5900 | 2500 | >570000 | >1100 | <3 | Negative |

The mint leaves alone (i.e., Controls 4A and 4B) had unacceptably high levels of microbes. However, the levels of microbes were significantly reduced by the addition of a mint flavor, as in Flavor Blends 5D-5G. The flavor compositions including mint flavor (i.e., Flavor Blends 5D-5G) had improved micro kill as compared to those with triacetin (i.e., Flavor Blends 5B and 5C), particularly with respect to levels of mold, yeast, and APC. All samples had acceptable levels of E. coli and were negative for salmonella. Flavor Blends 5B and 5C, which included only triacetin, magnolia bark extract and medium chain triglycerides, did not show an acceptable reduction in microbe levels as compared to the mint leaves alone. Moreover, when mint flavors were incorporated into a gum formulation, those gum formulations (e.g., Formulations 5D-5G) had acceptable levels of micro kill, and were generally improved as compared to those without mint flavor, particularly with respect to mold levels. In summary, gum formulations with pre-blended mint flavor and mint leaves can have improved micro kill.

### Example 6: Particle Size Testing of Large Leaf, Coarse, and Ground Mint Leaves

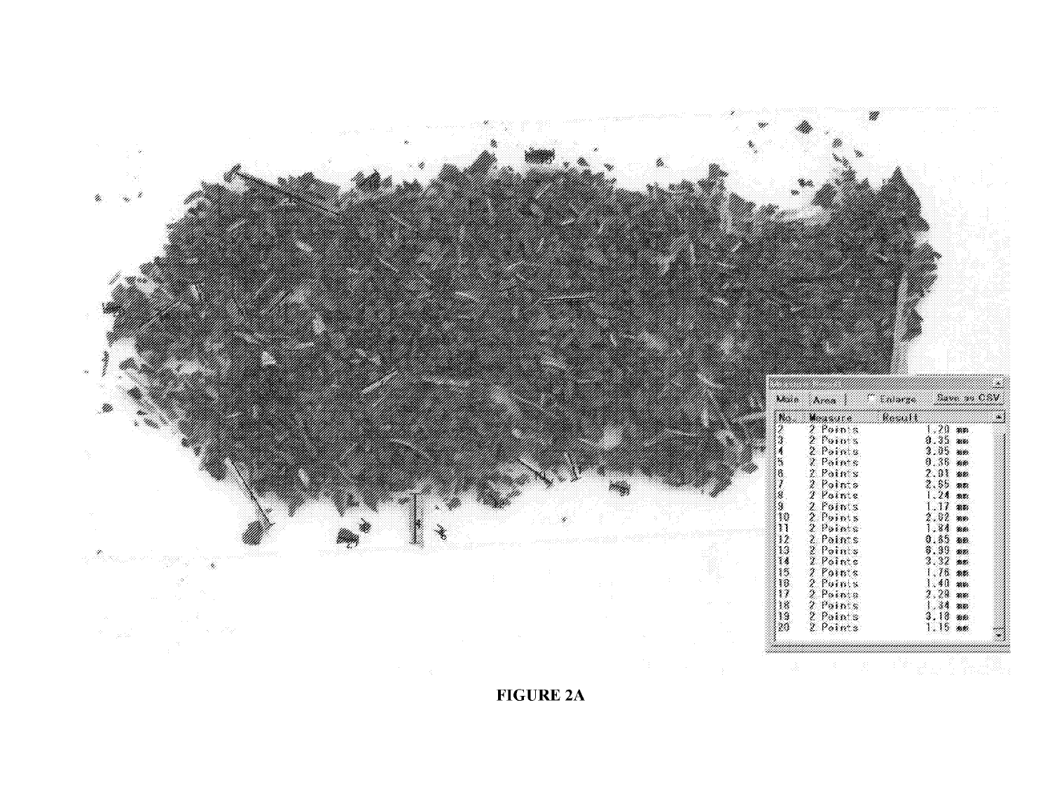

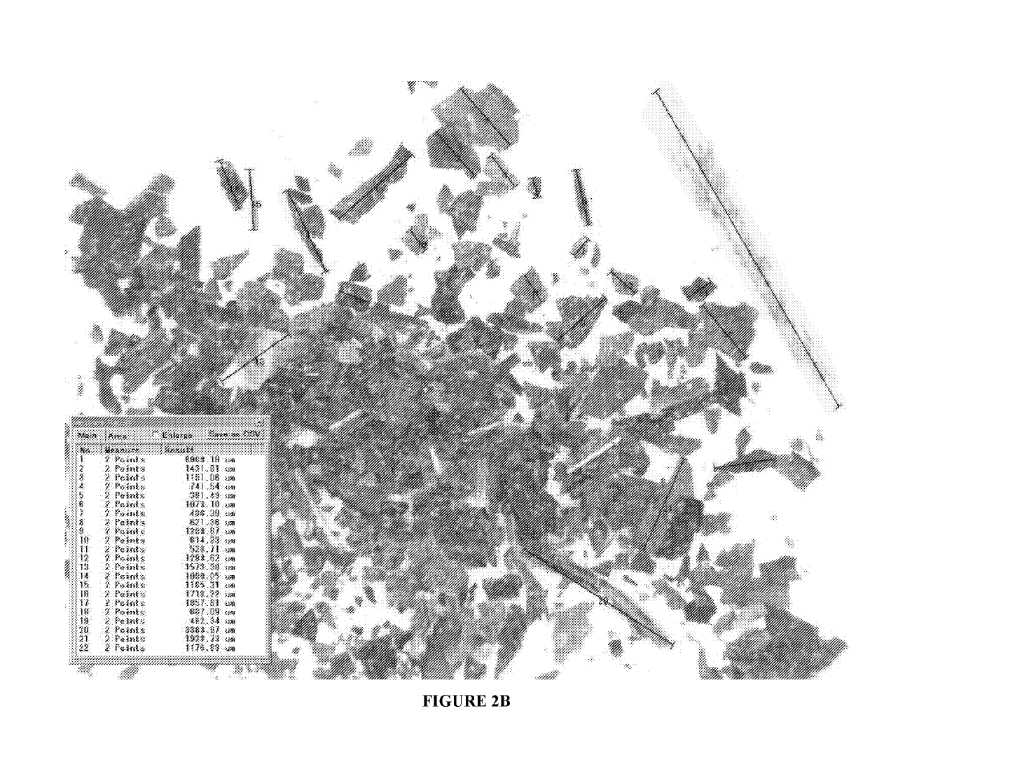

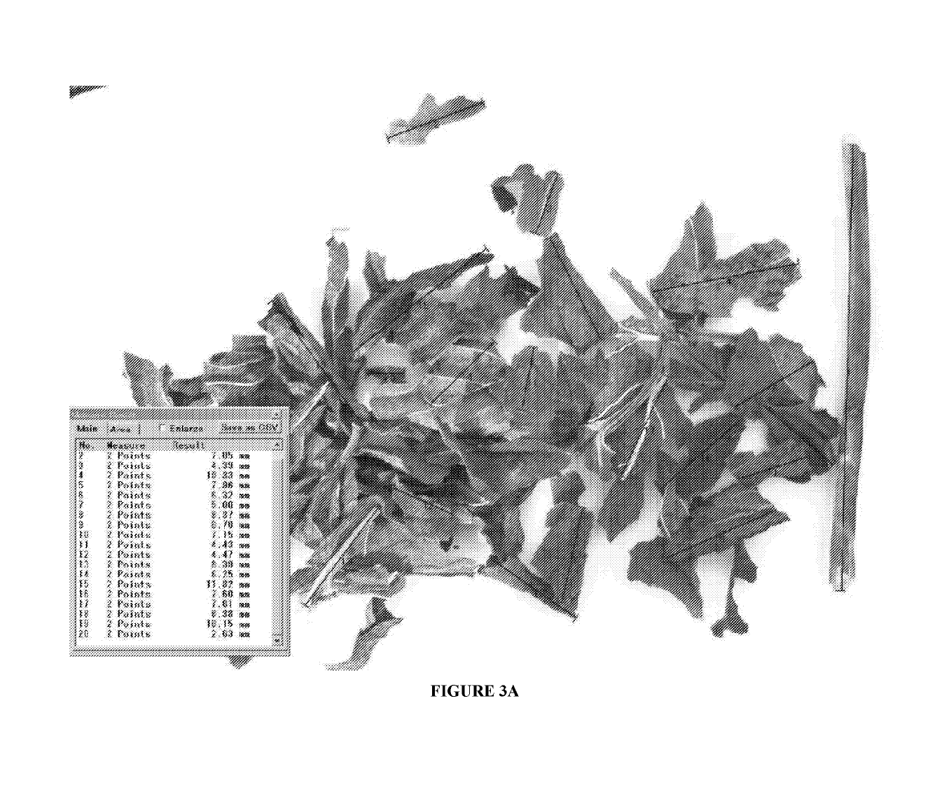

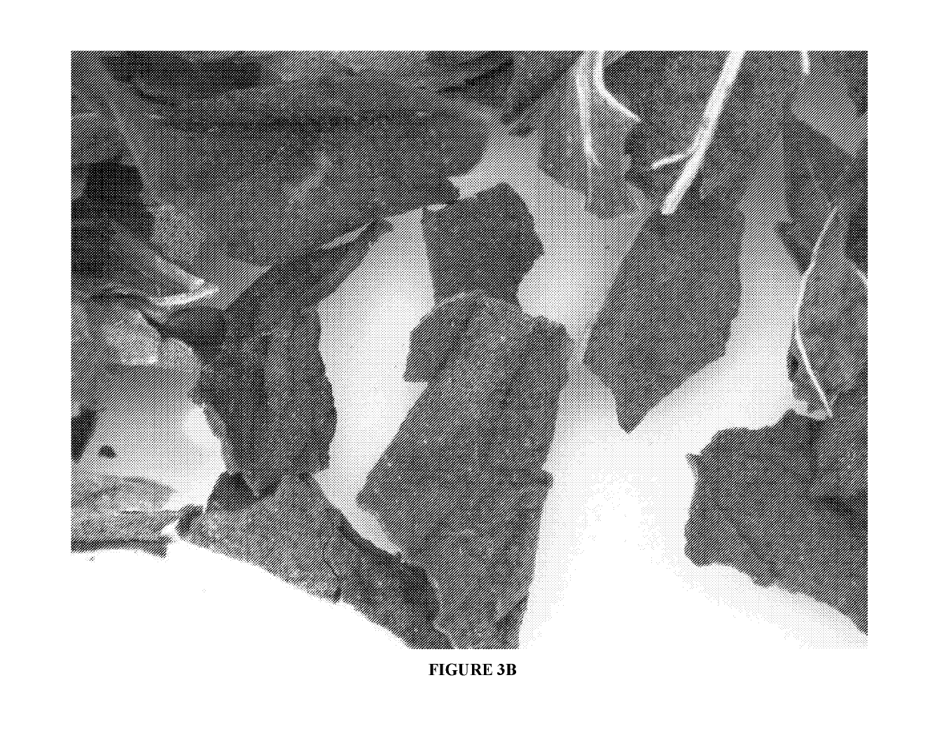

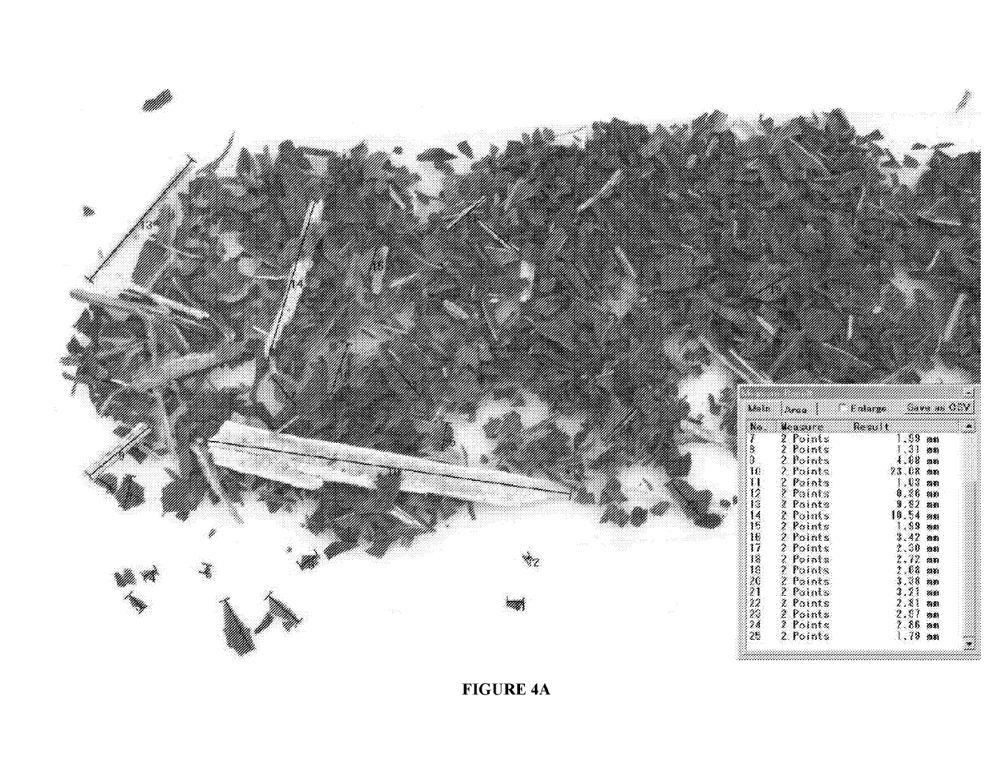

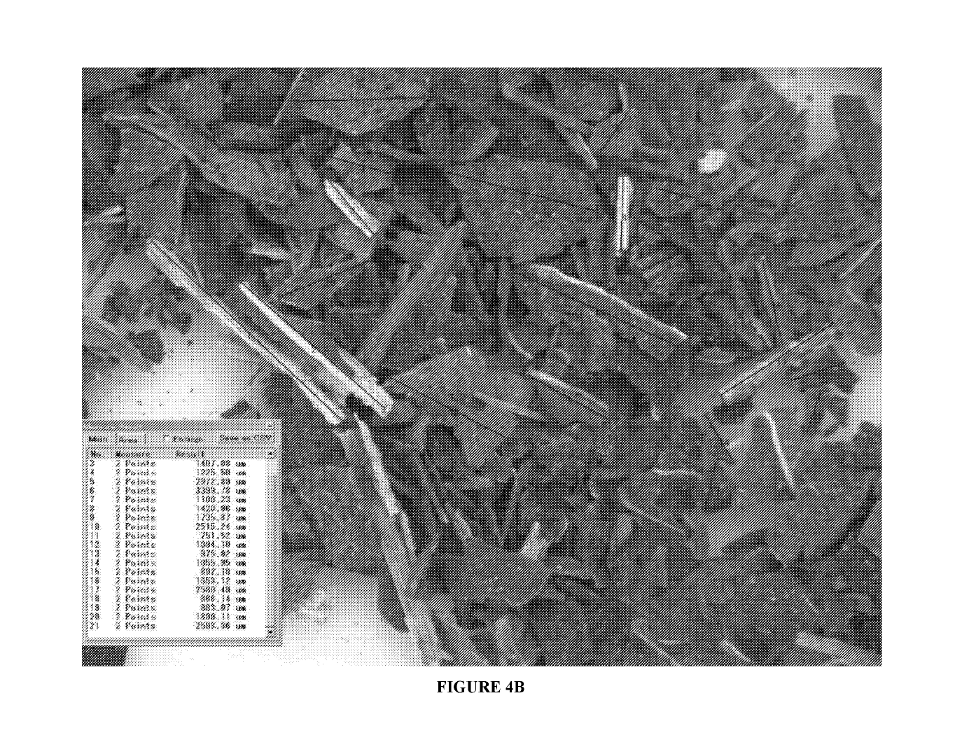

In this Example, microscopic analysis was used to determine the approximate particle sizes of mint leaves in various forms: large leaf, coarse, and ground. Each sample was dried. A first sample of ground mint leaves were coarse mint leaves that were ground once on a Turkish Grind. A second sample of ground mint leaves were large leaf mint leaves that were ground once on a Turkish Grind. The four mint leaf samples were each mounted dry on a glass microscope slide. The samples were then examined at 5×, 10× and 20× using a digital microscope with a top light (KEYENCE Corporation, Mechelen, Belgium). FIGS. 2A-5B provide the microscopic images at magnifications of 5× and 20×. FIGS. 2A and 2B are images of coarse mint leaves at 5× and 20×, respectively, and show the general size and shape of coarse mint leaves. FIGS. 3A and 3B are images of leaves ground from the coarse mint leaves at 5× and 20×, respectively, and show that the ground mint leaves are correspondingly smaller than the coarse leaves. FIGS. 4A and 4B depict large leaf mint leaves at 5× and 20×, respectively, and show that large leaves generally retain their natural size and shape. FIGS. 5A and 5B depict leaves ground from the large leaf mint leaves at 5× and 20×, respectively, and show the effect of grinding on full leaves.

Additionally, the microscopic images were used to approximately measure the length of several pieces of mint leaf from each sample. Bars indicating these lengths and their measured values are shown in FIGS. 2A-4A and 5A-5B. Further, these measurements are compiled for each of the samples in Table 11.

TABLE 11
Particle Size Data of Mint Leaf Samples

| | | Ground from | | Ground from |
|---|---|---|---|---|
| Sample | Coarse Leaf | Coarse Leaf | Large Leaf | Large Leaf |
| (units) | (mm) | (mm) | (mm) | (mm) |
| Average | 2.64 | 1.77 | 8.17 | 2.86 |
| Std. Dev. | 2.02 | 1.51 | 5.68 | 3.65 |
| Maximum | 11.58 | 6.99 | 30.36 | 23.08 |
| Minimum | 0.23 | 0.35 | 2.63 | 0.36 |
| Range | 11.35 | 6.64 | 27.73 | 22.72 |
| Count | 44 | 42 | 20 | 46 |

As shown in Table 11, the particle size of ground mint leaves can depend on the source of mint leaves. For example, the mint leaves that were ground from coarse leaves generally had smaller particle sizes than those ground from larger leaves. In addition to varying the source, finer particles could be achieved with additional grinding, e.g., by grinding the leaves two or more times on the Turkish Grind. Accordingly, the particle size of mint leaves can be adjusted, as needed.

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein may be utilized according to the presently disclosed subject matter. Accordingly, the appended claims are intended to include within their scope such processes, machines, manufacture, compositions of matter, means, methods, or steps.

Patents, patent applications publications product descriptions, and protocols are cited throughout this application the disclosures of which are incorporated herein by reference in their entireties for all purposes.

1. A flavor composition, comprising mint leaves and at least one mint flavor, wherein the flavor composition has improved micro kill as compared to a composition containing the mint leaves without mint flavor.

2. The flavor composition of claim 1, wherein the flavor composition has a microbe level reduction of at least 1 log as compared to the composition containing the mint leaves without mint flavor.

3. The flavor composition of claim 1, wherein the mint leaves are present in an amount of from about 1 wt-% to about 90 wt-%.

4. The flavor composition of claim 1, wherein the mint leaves are present in an amount of from about 25 wt-% to about 60 wt-%.

5. The flavor composition of claim 1, wherein the mint leaves are ground mint leaves.

6. The flavor composition of claim 1, wherein the mint flavor is present in an amount of from about 10 wt-% to about 99 wt-%.

7. The flavor composition of claim 1, wherein the mint flavor is present in an amount of from about 35 wt-% to about 75 wt-%.

8. The flavor composition of claim 1, wherein the mint flavor comprises at least one natural mint oil and/or mint extract.

9. The flavor composition of claim 1, wherein the mint flavor comprises menthol.

10. The flavor composition of claim 1, further comprising magnolia bark extract.

11. A confectionery product, comprising the flavor composition of claim 1.

12. (canceled)

13. A chewing gum, comprising the flavor composition of claim 1, wherein the flavor composition is present in the chewing gum in an amount of from about 0.01 wt-% to about 20 wt-%.

14. A method of making a chewing gum, comprising:
(a) blending mint leaves and mint flavor to form the flavor composition; and
(b) thereafter, incorporating the flavor composition with a gum base and bulking agent to form the chewing gum.

15. The method of claim 14, further comprising grinding the mint leaves prior to the blending.

16. The method of claim 14, further comprising aging the flavor composition for at least 7 days.

17. The method of claim 14, further comprising maintaining the flavor composition at a temperature of from about 40° C. to about 60° C. for from about 15 minutes to 1 hour.
